(19) United States
(12) Patent Application Publication
(10) Pub. No.: US 2019/0115738 A1
(43) Pub. Date: Apr. 18, 2019

(54) CABLE SUSPENSION CLAMPS

(71) Applicant: AFL Telecommunications LLC, Duncan, SC (US)

(72) Inventor: Wayne Quesnel, Moore, SC (US)

(21) Appl. No.: 15/782,459

(22) Filed: Oct. 12, 2017

(51) Int. Cl. H02G 7/05; F16L 3/12

(52) U.S. Cl. CPC H02G 7/053; G02B 6/48; F16L 3/12

(57) ABSTRACT

A cable suspension clamp includes a first clamp body and a second clamp body. Each of the first clamp body and the second clamp body define a cable receiving region, wherein the cable receiving regions of the first clamp body and the second clamp body together define a cable channel which extends along a longitudinal direction. The second clamp body is selectively movable relative to the first clamp body along the transverse direction between an open position and a closed position. The first clamp body and the second clamp body together define the cable channel when the second clamp body is in the closed position.

### FIELD

The present disclosure relates generally to cable suspension clamps.

### BACKGROUND

Cables, such as optical ground wire (“OPGW”), power, communications, or other suitable cables, are in many cases aerially suspended from poles or other suitable support structures. Such aerial configuration advantageously limits the necessary ground footprint and safely places the cables out of reach of people, vehicles, animals, etc.

To suspend such cables from associated support structures, cable suspension clamps are typically utilized. These clamps support the cable and provide an interface between the cable and the support structure. In some cases, upper and lower clamp bodies are assembled around a cable in a vertical manner, and fasteners are then inserted through the clamp bodies to secure the clamp bodies together, forming a clamp around the cable. However, in these designs, the fasteners are separate from the clamp bodies until being inserted therein to secure the clamp, and are thus easily susceptible to being misplaced in the field. Additionally, due to the use of such separate parts, assembly of a clamp can be difficult. For example, the worker must hold both clamp bodies together while inserting and tightening the fasteners. In other cases, hinged clamp bodies have been utilized. However, these designs are difficult to initially position on the cables, leading to delays in assembly times.

Accordingly, improved cable suspension clamps are desired. For example, cable suspension clamps which are relatively easy and efficient to assemble while reducing the risk of components thereof being misplaced would be advantageous.

### BRIEF DESCRIPTION

Aspects and advantages of the invention will be set forth in part in the following description, or may be obvious from the description, or may be learned through practice of the invention.

In accordance with one embodiment, a cable suspension clamp is provided. The cable suspension clamp includes a first clamp body and a second clamp body. Each of the first clamp body and the second clamp body define a cable receiving region, wherein the cable receiving regions of the first clamp body and the second clamp body together define a cable channel which extends along a longitudinal direction. The second clamp body is selectively movable relative to the first clamp body along the transverse direction between an open position and a closed position. The first clamp body and the second clamp body together define the cable channel when the second clamp body is in the closed position.

In accordance with another embodiment, a cable suspension clamp is provided. The cable suspension clamp includes a first clamp body and a second clamp body. Each of the first clamp body and the second clamp body define a cable receiving region, wherein the cable receiving regions of the first clamp body and the second clamp body together define a cable channel which extends along a longitudinal direction. Each of the first clamp body and the second clamp body further define a clamp body coupling region and a clamp body securing region. The clamp body securing region and the clamp body coupling region of each of the first clamp body and second clamp body are located on opposing sides of the cable receiving region of that one of the first clamp body or second clamp body along a vertical direction. The second clamp body is selectively movable relative to the first clamp body along the transverse direction between an open position and a closed position. The first clamp body and the second clamp body together define the cable channel when the second clamp body is in the closed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION

A full and enabling disclosure of the present invention, including the best mode thereof, directed to one of ordinary skill in the art, is set forth in the specification, which makes reference to the appended figures, in which:

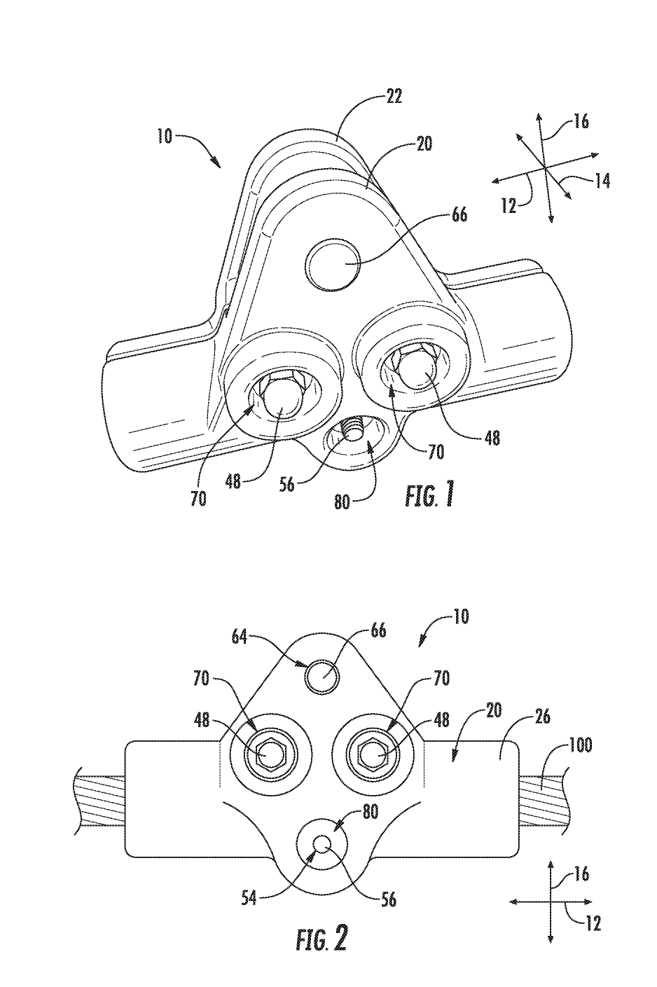

FIG. 1 is a perspective view of a cable suspension clamp in accordance with embodiments of the present disclosure;

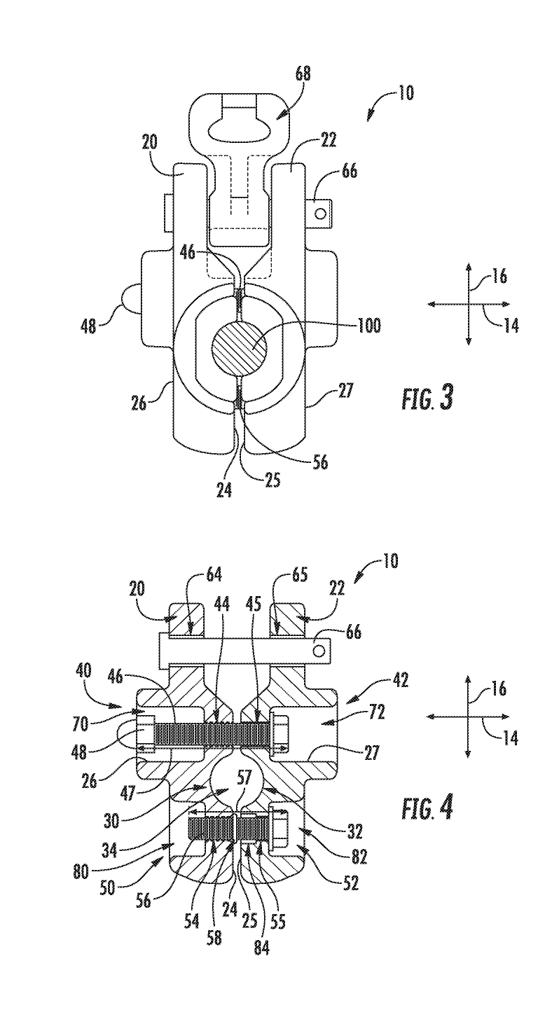

FIG. 2 is a side view of a cable suspension clamp in accordance with embodiments of the present disclosure;

FIG. 3 is an end view of a cable suspension clamp in accordance with embodiments of the present disclosure;

FIG. 4 is an end cross-sectional view of a cable suspension clamp, with a bolt in a second position and a clamp body in a closed position, in accordance with embodiments of the present disclosure;

FIG. 5 is an end cross-sectional view of a cable suspension clamp, with a bolt in a first position and a clamp body in a closed position, in accordance with embodiments of the present disclosure;

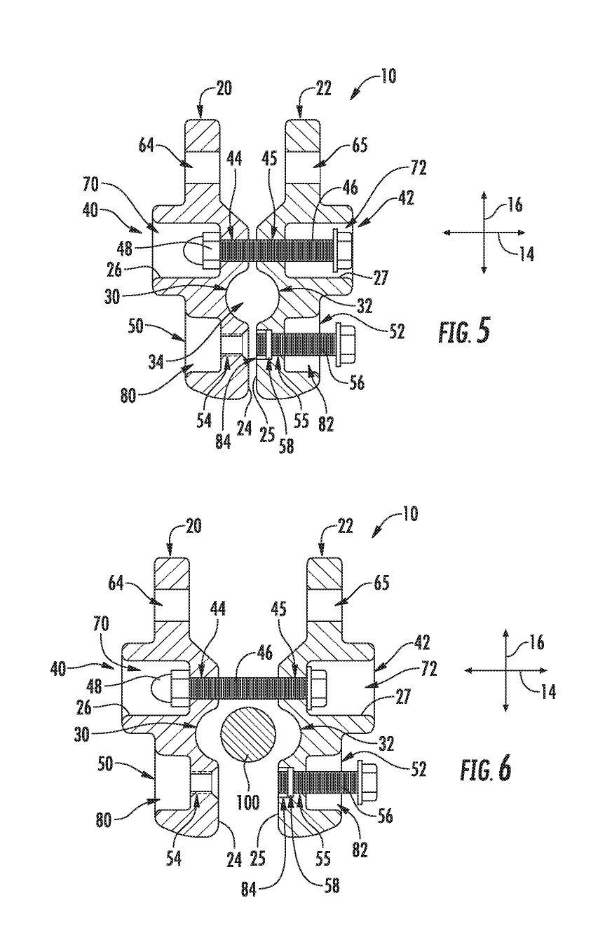

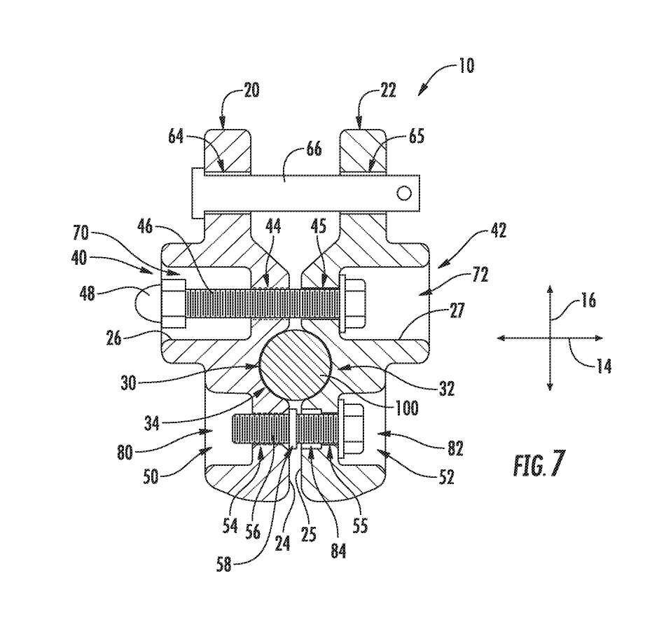

FIG. 6 is an end cross-sectional view of a cable suspension clamp, with a bolt in a first position and a clamp body in an open position, in accordance with embodiments of the present disclosure; and

FIG. 7 is an end cross-sectional view of a cable suspension clamp, with a bolt in a second position and a clamp body in a closed position after insertion of a cable therein, in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to FIGS. 1 through 7, cable suspension clamps 10 in accordance with the present disclosure are illustrated. In general, a cable suspension clamp 10 supports a cable 100. Cable 100 is in exemplary embodiments an overhead cable, such as an OPGW, power, communications, or other suitable cable. Clamps 10 in accordance with the present disclosure are easily and efficiently connectable to such cables 100 to clamp a cable 100 within the clamp 10. Further, during such assembly, the structure of clamps 10 in accordance with the present disclosure reduces the risk of loss of the components thereof.

In general, an orthogonal coordinate system may be defined for clamps 10 in accordance with the present disclosure. Accordingly, clamp 10 may be defined along a longitudinal direction 12, a transverse direction 14, and a vertical direction 16, all of which may be mutually orthogonal.

As shown, a cable suspension clamp 10 includes a first clamp body 20 and a second clamp body 22. Clamp bodies 20, 22 may be formed from any suitable materials, such as suitable metals or polymers. In exemplary embodiments, clamp bodies 20, 22 may be formed from aluminum, such as cast aluminum. Each clamp body 20, 22 may include an inner surface 24, 25, respectively, and an outer surface 26, 27, respectively, as shown.

Clamp bodies 20, 22 may be clamped together around a portion of a cable 100, such that the cable 100 is clamped in place therebetween. Accordingly, each clamp body 20, 22 may define a cable receiving region 30, 32. The cable receiving regions 30, 32 may generally be troughs that are defined in the inner surfaces 24, 25 of the clamp bodies 20, 22 and which extend along the longitudinal direction 12. When the clamp bodies 20, 22 are assembled together, such that the inner surfaces 24, 25 are in contact or proximate each other in a closed position as discussed herein, the cable receiving regions 30, 32 may define a cable channel 34 which extends along the longitudinal direction 12. A cable 100 may thus be positioned in and extend through the cable channel 34 for support by the clamp 10.

Second clamp body 22 may be selectively movable relative to the first clamp body 20 along the transverse direction 14 between an open position, as illustrated in FIG. 6, and a closed position, as illustrated in FIGS. 1-5 and 7. In the open position, sufficient space is provided between the clamp bodies 20, 22 (such as the inner surfaces 24, 25 thereof) such that a cable 10 can be inserted therebetween or removed from therebetween. In the closed position, the cable channel 34 is defined and the cable 100 may be clamped between the clamp bodies 20, 22 (such as the inner surfaces 24, 25 thereof) within the cable channel 34. Notably, such movement is generally a sliding, translational movement along the transverse direction 14. In exemplary embodiments and as shown, no pivoting of the second clamp body 22 relative to the first clamp body 20 (or vice versa) occurs during assembly/disassembly of the clamp 10. Rather, the necessary movement which occurs during assembly of clamp bodies 20, 22 to form a clamp 10 is translational.

The clamp bodies 20, 22 may each further define a clamp body coupling region 40, 42. The coupling regions 40, 42 facilitate the translational movement of the clamp bodies 20, 22 between the open and closed positions as discussed herein, thus providing coupling movements between the clamp bodies 20, 22. Each clamp body coupling region 40, 42 may, for example, include one or more bores 44, 45 which are defined in the respective clamp body 20, 22. Each bore 44, 45 may extend along the transverse direction 14 through the respective clamp body 20, 22.

In exemplary embodiments a plurality of bores 44, 45 may be included in a clamp body coupling region 40, 42 and thus defined in a clamp body 20, 22, such as two as shown or more. Alternatively, however, only one such bore 44, 45 may be utilized. When two (or more) bores 44, 45 are utilized for a clamp body 20, 22, the bores 44, 45 may in some embodiments be spaced apart along the longitudinal direction 12, such as coaxially along the longitudinal direction 12. Alternatively, other suitable arrangements of the bores 44, 45 may be utilized.

The bores 44, 45 may be arranged in one or more pairs of bores 44, 45, with the bores 44, 45 of each pair being aligned along the transverse direction 14.

In exemplary embodiments, clamp 10 may, for example, include one or more bolts 46 (which may be referred to herein as first bolts 46). In some embodiments, for example, a plurality of bolts 46 may be provided. The number of bolts 46 may be equal to the number of pairs of bores 44, 45. Each bolt 46 may extend through a pair of bores 44, 45.

Further, second clamp body 22 may be selectively movable along the transverse direction 14 relative to the bolts 46. When movable, such movement may be between the open and closed positions as discussed herein. To facilitate such selective movement of the second clamp body 22, the bolt(s) 46 may be movable along the transverse direction 14 (relative to the first clamp body 20) between a first position and a second position. In the first position, as illustrated in FIGS. 5 and 6, movement of the second clamp body 22 relative to the first clamp body 20 along the transverse direction 14 between the open position and the closed position is permitted. In the second position, as illustrated in FIGS. 1-4 and 7, movement of the second clamp body 22 relative to the first clamp body 20 along the transverse direction 14 between the open position and the closed position is restricted.

For example, the bore(s) 44 of the first clamp body 20 may be threaded, such as with inner threads. The bore(s) 45 of the second clamp body 22 may be non-threaded, and may for example be drilled through-holes. Accordingly, second clamp body 22 may be movable relative to the bolt(s) 46 when sufficient space is provided along the transverse direction 14 to facilitate such movement. In the first position, the bolt(s) 46 may be loosened relative to the first clamp body 20 so that such movement of the second clamp body 22 is permitted, which in the second position, the bolt(s) 46 may be tightened relative to the first clamp body 20 so that such movement of the second clamp body 22 is restricted.

In exemplary embodiments, a nut 48 may be connected to each bolt 46. In exemplary embodiments, nut 48 may be an acorn nut. Nut 48 may be disposed proximate first clamp body 20, such as the outer surface 26 thereof. Each nut 48 may prevent a corresponding bolt 46 from moving past a first position and out of bore 44, thus reducing the risk of loss of such bolt 46 and/or a clamp body 20, 22. When a bolt 46 is in the first position, the corresponding nut 48 may be relatively more proximate the outer surface 26 (such as in some embodiments in contact with the outer surface 26) relative to when the bolt 46 is in the second position and the nut 48 is spaced from the outer surface 26. Additionally, the use of nuts 48 may advantageously protect the associated bolts 46 from corona discharge.

The clamp bodies 20, 22 may each further define a clamp body securing region 50, 52. The securing regions 50, 52 facilitate securing of the clamp bodies 20, 22 together in the closed position. In exemplary embodiments, the clamp body securing region 50, 52 and the clamp body coupling region 40, 42 of each respective clamp body 20, 22, are located on opposing sides of the cable receiving region 30, 32 of that respective clamp body 20, 22 along the vertical direction 16, as shown.

Each clamp body securing region 50, 52 may, for example, include one or more bores 54, 55 which are defined in the respective clamp body 20, 22. Each bore 54, 55 may extend along the transverse direction 14 through the respective clamp body 20, 22.

Clamp 10 may, for example, include one or more bolts 56 (which may be referred to herein as second bolts 56). In some embodiments, for example, a plurality of bolts 56 may be provided. The number of bolts 56 may be equal to the number of pairs of bores 54, 55. Each bolt 56 may extend through a pair of bores 54, 55.

In exemplary embodiments, bolt(s) 56 may be removed from the corresponding bore(s) 54 to facilitate movement of the second clamp body 22 from the closed position to the open position. When the second clamp body 22 is returned from the open position to the closed position, the bolt(s) 56 may be inserted into the corresponding bore(s) 54 to secure the clamp bodies 20, 22, and the clamp 10 generally, together in the closed position.

In some embodiments, as illustrated, an O-ring 58 may be provided on each bolt 56. As shown for example in FIG. 6, O-ring 58 may contact the inner surface 25 of the second clamp body 22 when the bolt 56 is removed from the corresponding bore 54. Such contact may prevent the bolt 56 from being removed from the corresponding bore 55, thus reducing the risk of loss of such bolt 56.

In some embodiments, the bore(s) 54 of the first clamp body 20 may be threaded, such as with inner threads. The bore(s) 55 of the second clamp body 22 may be non-threaded, and may for example be drilled through-holes.

In some embodiments, maximum lengths 57 of the second bolt(s) 56 are less than the maximum lengths 47 of the first bolt(s) 46. Such relative lengths facilitate ease of removal of the second bolt(s) 56, and ease of movement of the second clamp body 22 between the open and closed positions.

In exemplary embodiments, outer sockets may be defined in the clamp bodies 20, 22. Such sockets, which may define portions of the outer surfaces 26, 27, may advantageously house and protect portions of the bolts, thus reducing the risk of corona discharge issues as well as mechanical issues such as bolt damage, etc. For example, sockets 70, 72 may be defined in the clamp bodies 20, 22 within the clamp body coupling regions 40, 42, respectively. Each socket 70 may be in communication with a corresponding bore 44, and each socket 72 may be in communication with a corresponding bore 45. Portions of bolts 46 may thus be disposed within sockets 70, 72. Further, sockets 80, 82 may be defined in the clamp bodies 20, 22 within the clamp body securing regions 50, 52, respectively. Each socket 80 may be in communication with a corresponding bore 54, and each socket 82 may be in communication with a corresponding bore 55. Portions of bolts 56 may thus be selectively disposed within sockets 80, 82.

Additionally, in some embodiments, inner socket(s) 84 may be defined in the second clamp body 22. Such inner socket 84, which may define a portion of the inner surface 25, may advantageously house and protect an associated bolt 56 and O-ring 58 when the O-ring is removed from the corresponding bore 54. Socket 84 may, for example, be in communication with a corresponding bore 55. As illustrated in FIGS. 5 and 6, when a bolt 56 is removed from bore 54, the O-ring 58 and the end of the bolt 56 may be moved to a position wherein they are housed within the inner socket 84. In addition to protecting the bolt 56 and O-ring, the use of inner socket 84 may advantageously prevent damage to cable 100 via contact with bolt 56 as the cable 100 is being inserted into or removed from the cable receiving regions 30, 32 and cable channel 34 formed thereby.

To insert a cable 100 into clamp 10, bolt(s) 46 may be moved from the second positions (see FIG. 4) to the first positions (see FIG. 5) and bolt(s) 56 may be removed from the bore(s) 54. Second clamp body 22 may then be moved from the closed position (see FIG. 5) to the open position (see FIG. 6). A cable 100 may be inserted between and into cable receiving regions 30, 32 (see FIG. 6). Second clamp body 22 may then be moved from the open position (see FIG. 6) to the closed position (see FIG. 7). Bolt(s) 46 may be moved from the first positions (see FIG. 6) to the second positions (see FIG. 7) and bolt(s) 56 may be inserted into the bore(s) 54. To remove the cable 100, the same pattern of steps may occur, with the cable 100 removed from between and in the cable receiving regions 30, 32.

Each clamp body 20, 22 may further include one or more bores 64, 65 which are defined in the respective clamp body 20, 22. Each bore 64, 65 may extend along the transverse direction 14 through the respective clamp body 20, 22. Further, a pin (such as a clevis pin) 66 may extend through a pair of bores 64, 65. Referring to FIG. 3, a socket eye 68 may be supported by the pin 66 between the clamp bodies 20, 22. The socket eye 68 may couple the clamp 10 to a pole or other suitable support structure, such as by sliding onto the end of an insulator. Alternatively, other suitable suspending apparatus may be utilized.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A cable suspension clamp, comprising:
a first clamp body and a second clamp body, each of the first clamp body and the second clamp body defining a cable receiving region, wherein the cable receiving regions of the first clamp body and the second clamp body together define a cable channel which extends along a longitudinal direction,
wherein the second clamp body is selectively movable relative to the first clamp body along a transverse direction between an open position and a closed position, and
wherein the first clamp body and the second clamp body together define the cable channel when the second clamp body is in the closed position.

2. The cable suspension clamp of claim 1, wherein each of the first clamp body and the second clamp body further define a clamp body coupling region, the clamp body coupling region comprising a bore which extends along the transverse direction, and further comprising a bolt which extends through the bores of the clamp body coupling regions of the first clamp body and the second clamp body, wherein the second clamp body is selectively movable along the transverse direction relative to the bolt.

3. The cable suspension clamp of claim 2, wherein the bore of the first clamp body is threaded and the bore of the second clamp body is non-threaded.

4. The cable suspension clamp of claim 2, wherein the bolt is movable along the transverse direction between a first position and a second position, wherein in the first position movement of the second clamp body relative to the first clamp body along the transverse direction between the open position and the closed position is permitted, and wherein in the second position movement of the second clamp body relative to the first clamp body along the transverse direction between the open position and the closed position is restricted.

5. The cable suspension clamp of claim 2, wherein the clamp body coupling region of each of the first clamp body and the second clamp body comprises a plurality of bores, and wherein the bolt is a plurality of bolts.

6. The cable suspension clamp of claim 2, further comprising a nut connected to the bolt.

7. The cable suspension clamp of claim 6, wherein the nut is an acorn nut.

8. The cable suspension clamp of claim 1, wherein the second clamp body is non-pivotable relative to the first clamp body.

9. The cable suspension clamp of claim 1, wherein each of the first clamp body and the second clamp body further define a clamp body securing region, the clamp body securing region comprising a bore which extends along the transverse direction, and further comprising a bolt which extends through the bores of the clamp body securing regions of the first clamp body and the second clamp body.

10. The cable suspension clamp of claim 9, wherein the bore of the first clamp body is threaded and the bore of the second clamp body is non-threaded.

11. The cable suspension clamp of claim 2, wherein each of the first clamp body and the second clamp body further define a clamp body securing region, the clamp body securing region comprising a bore which extends along the transverse direction, and further comprising a bolt which extends through the bores of the clamp body securing regions of the first clamp body and the second clamp body, wherein the bolt extending through the bores of the clamp body securing regions has a maximum length which is less than a maximum length of the bolt extending through the bores of the clamp body coupling regions.

12. The cable suspension clamp of claim 11, wherein the clamp body securing region and the clamp body coupling region of each of the first clamp body and second clamp body are located on opposing sides of the cable receiving region of that one of the first clamp body or second clamp body along a vertical direction.

13. A cable suspension clamp, comprising:
a first clamp body and a second clamp body, each of the first clamp body and the second clamp body defining a cable receiving region, wherein the cable receiving regions of the first clamp body and the second clamp body together define a cable channel which extends along a longitudinal direction, each of the first clamp body and the second clamp body further defining a clamp body coupling region and a clamp body securing region, wherein the clamp body securing region and the clamp body coupling region of each of the first clamp body and second clamp body are located on opposing sides of the cable receiving region of that one of the first clamp body or second clamp body along a vertical direction,
wherein the second clamp body is selectively movable relative to the first clamp body along a transverse direction between an open position and a closed position, and
wherein the first clamp body and the second clamp body together define the cable channel when the second clamp body is in the closed position.

14. The cable suspension clamp of claim 13, wherein each clamp body coupling region comprising a bore which extends along the transverse direction, and further comprising a bolt which extends through the bores of the clamp body coupling regions of the first clamp body and the second clamp body, wherein the second clamp body is selectively movable along the transverse direction relative to the bolt.

15. The cable suspension clamp of claim 14, wherein the bore of the first clamp body is threaded and the bore of the second clamp body is non-threaded.

16. The cable suspension clamp of claim 14, wherein the bolt is movable along the transverse direction between a first position and a second position, wherein in the first position movement of the second clamp body relative to the first clamp body along the transverse direction between the open position and the closed position is permitted, and wherein in the second position movement of the second clamp body relative to the first clamp body along the transverse direction between the open position and the closed position is restricted.

17. The cable suspension clamp of claim 14, further comprising a nut connected to the bolt.

18. The cable suspension clamp of claim 13, wherein the second clamp body is non-pivotable relative to the first clamp body.

19. The cable suspension clamp of claim 13, wherein each clamp body securing region comprising a bore which extends along the transverse direction, and further comprising a bolt which extends through the bores of the clamp body securing regions of the first clamp body and the second clamp body.

20. The cable suspension clamp of claim 19, wherein the bore of the first clamp body is threaded and the bore of the second clamp body is non-threaded.
